(19) United States
(12) Patent Application Publication
(10) Pub. No.: US 2009/0185309 A1
(43) Pub. Date: Jul. 23, 2009

(54) Method for Minimizing Contaminant Levels Within a Tape Drive System

(76) Inventors: Allen Keith Bates, Tucson, AZ (US); Nhan X. Bui, Tucson, AZ (US); Randall S. Doan, Tucson, AZ (US); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 12/016,284

(22) Filed: Jan. 18, 2008

(51) Int. Cl. G11B 33/14

(52) U.S. Cl. 360/97.02

(57) ABSTRACT

A method for minimizing dust level within a tape drive system is disclosed. A dust concentration level within the tape drive system is initially determined. A head brush interval is subsequently adjusted according to the determined dust concentration level within the tape drive system.

### BACKGROUND OF THE INVENTION

1. Technical Field

The present invention relates to data storage systems in general, and more particularly, to a tape drive system. Still more particularly, the present invention relates to a method for minimizing contaminant levels within a tape drive system.

2. Description of Related Art

During the insertion of a tape cartridge into a tape drive system, contaminants, such as dust, can be pulled into the tape drive system from the loading area in which the tape cartridge is inserted. When the tape cartridge is subject to a load/unload operation, dust that has accumulated around the tape cartridge in the loading area is disturbed and may be drawn into the tape drive system by a cooling fan. The dust may eventually be deposited on a read/write tape head of the tape drive system. In time, the dust may cause the tape drive system to suffer failures due to the inability to read servo landmark information and/or read and write data.

The dust problem can be overcome by incorporating a head brush cleaning procedure at every unload/load operation. However, the head brush cleaning procedure adds extra time to every unload operation, which may be unacceptable for a library automation application, such as the IBM 3584 tape library where a robotic arm loads tape cartridges to or unloads tape cartridges from tape drives and stores tape cartridges in storage slots when they are not in tape drives.

Consequently, it would be desirable to provide a method for minimizing contaminant levels within a tape drive system.

### SUMMARY OF THE INVENTION

In accordance with a preferred embodiment of the present invention, a dust concentration level within a tape drive system is initially determined. A head brush interval is subsequently adjusted according to the determined dust concentration level within the tape drive system.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an isometric view of a tape drive system, in accordance with a preferred embodiment of the present invention; and

FIG. 2 is a high-level logic flow diagram of a method for minimizing dust levels within the tape drive system of FIG. 1, in accordance with a preferred embodiment of the present invention.

### DETAILED DESCRIPTION OF A PREFERRED EMBODIMENT

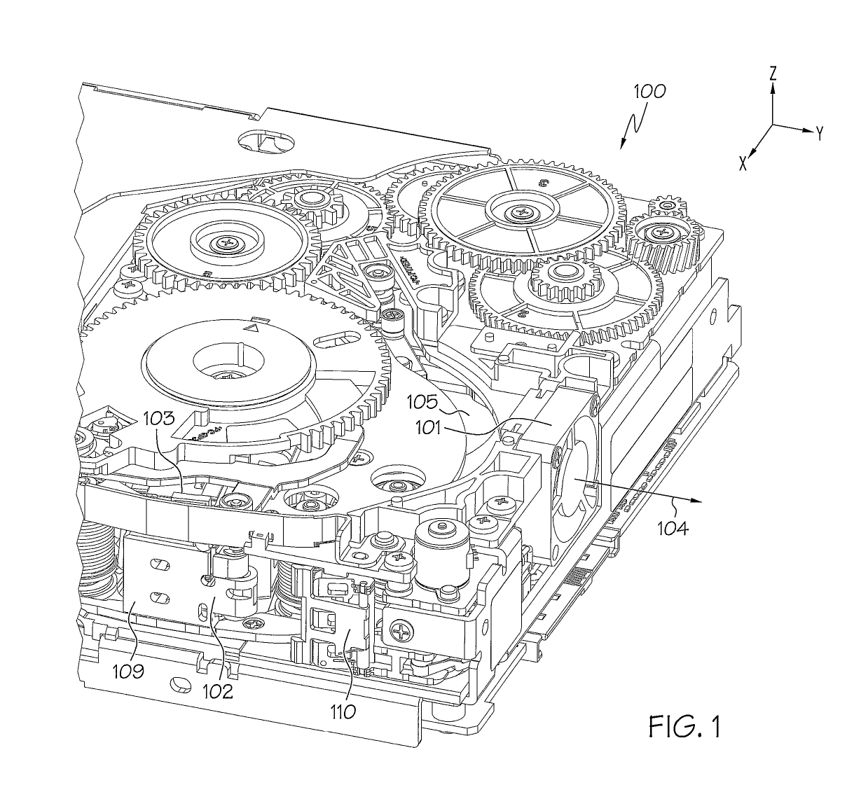

With reference now to the drawings, and in particular to FIG. 1, there is illustrated an isometric view of a tape drive system in which a preferred embodiment of the present invention is incorporated. As shown, a tape drive system 100 includes a fan 101 that provides airflow, a leader block 102, a tape head 103 and a head brush 110 for cleaning tape head 103. A leader block path 105 shows the path of leader block 162. Airflow provided by fan 101 normally comes out the back of tape drive system 100 in a direction 104 of the +Y axis, for the purpose of cooling tape drive system 100 by pulling hot air out of tape drive system 100.

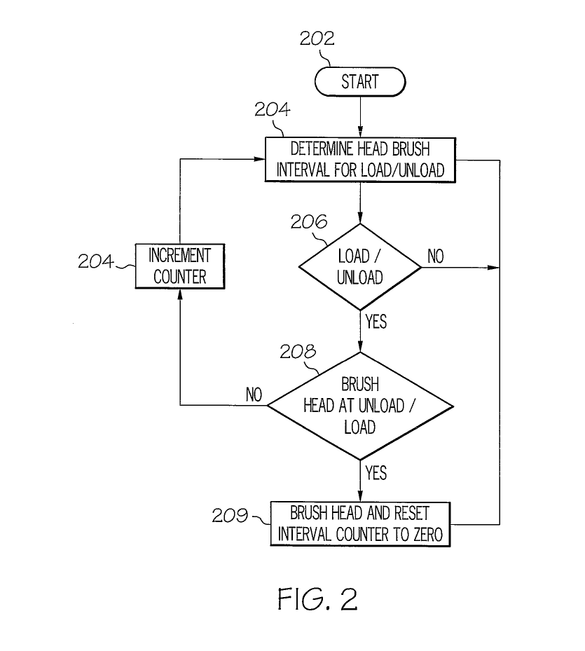

With reference now to FIG. 2, there is a high-level logic flow diagram of a method for minimizing dust level within a tape drive system, such as tape drive system 100 of FIG. 1, in accordance with a preferred embodiment of the present invention. Starting at block 202, a head brush interval for a load/unload operation is computed based on inputs from a dust sensor and information obtained from a drive interface, vital product data (VPD) settings, etc., as shown in block 204. A bit in a VPD can be set to enable an application (such as an automation library, server or bridge box) to dynamically decide whether or not to enable a head brush interval during an unload operation.

Automation libraries use a private communication link for monitoring and controlling the removable media drives installed in them. The Automation/Drive Interface (ADI)—Transport Protocol standard, as defined by the InterNational Committee on Information Technology Standards (see http:www.t10.org), specifies a protocol for transporting commands, data, and status between automation devices and media drives. The ADI or analogous library drive interface (LDI) can also command a tape drive to enable the head brush interval (for example, every tenth unload/load operation). The head brush interval can be changed from one to a maximum value, including never brushing the tape head until a cleaning cartridge is requested by the tape drive system. Also, a dust sensor residing in the application can sense periods of high dust concentration and modify the head brush interval to compensate for the change in dust concentration. The dust sensor can be an optical sensor looking at the amount of light reflected off of tape head 103, where a dusty tape head reflects less light than a clean tape head. Such an optical dust sensor may include a light emitting diode and phototransistor (LED-PTX) pair, and the voltage output of the phototransistor give the indication of dust.

Additionally, excessive write-verify (read-after-write) errors or excessive read errors encountered by tape drive system 100 can lead to modification of the head brush interval. These write-verify and read errors are measured by the I/O channel via data written to and read from a magnetic tape by tape head 103. Other indicators of dust may include tape head 103 being unable to read the timing-based-servo written on a magnetic tape by a tape manufacturer. Still another indication of dust can be excessive usage of a cleaner cartridge by tape drive system 100.

Alternatively, a dust sensor residing in tape drive system 100 can signal tape drive microcode to modify a head brush interval to compensate for the change in dust concentration measured by the dust sensor. The head brush interval can be changed from one to a maximum value, including never brushing the head until a cleaning cartridge is requested by tape drive system 100.

A determination is made whether or not there is a load/unload operation being performed, as depicted in block 206. If no load/unload operation is detected, the process returns to block 204. Otherwise, if a load/unload operation is detected, another determination is made whether or not a counter agrees with the computed head brush interval, as shown in block 208. If the counter does not agree with the head brush interval, then the counter is incremented, as depicted in block 210, and the process returns to block 204. However, if the counter agrees with the head brush interval, then the tape head is brushed and the interval counter is reset to zero, as shown in block 209, and the process returns to block 204.

As has been described, the present invention provides a method for minimizing contaminant level within a tape drive system.

While an illustrative embodiment of the present invention has been described in the context of a fully functional tape drive system, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as solid-state thumb drives, floppy disks, hard disk drives, CD ROMs, DVDs, HD-DVDs, Blu-Ray Disk, ultra-density optical, and transmission type media such as digital and analog communication links. These communication links may involve, including without limitation a Fibre Channel loop, Small Computer System Interface (SCSI), Internet SCSI (iSCSI), Serial Attach SCSI (SAS), Fibre Channel, SCSI over Fibre Channel, Ethernet, Fibre Channel over Ethernet (FCoE), Infiniband, and SATA (Serial ATA. over optical fibre or copper.

While the invention has been particularly shown and described with reference to a preferred embodiment, it will be understood by those skilled in the art that various changes in form and detail may be made therein without departing from the spirit and scope of the invention.

What is claimed is:

1. A method for minimizing contaminant levels within a tape drive system, said method comprising:
determining a dust concentration level within a tape drive system; and
adjusting a head brush interval according to said dust concentration level within said tape drive system.

2. The method of claim 1, wherein said dust concentration level is determined by a dust sensor.

3. The method of claim 2, wherein said dust sensor determines said dust concentration level by sensing light reflected off of a tape head.

4. The method of claim 1, wherein said dust concentration level is determined by a number of write-verify errors.

5. The method of claim 1, wherein said dust concentration level is determined by a number of read errors.

6. The method of claim 1, wherein said dust concentration level is determined by an inability to read the timing based servo written to a magnetic tape by a tape manufacturer.

7. The method of claim 1, wherein said dust concentration level is determined by an excessive use of a cleaner cartridge.

8. A computer readable medium having a computer program product for performing parallel data indexing within a data storage system, said computer readable medium comprising:
computer program code for determining a dust concentration level within a tape drive system; and
computer program code for adjusting a head brush interval according to said dust concentration level within said tape drive system.

9. The computer readable medium of claim 8, wherein said dust concentration level is determined by a dust sensor.

10. The computer readable medium of claim 9, wherein said dust sensor determines said dust concentration level by sensing light reflected off of a tape head.

11. The computer readable medium of claim 8, wherein said dust concentration level is determined by a number of write-verify errors.

12. The computer readable medium of claim 8, wherein said dust concentration level is determined by a number of read errors.

13. The computer readable medium of claim 8, wherein said dust concentration level is determined by an inability to read the timing based servo written to a magnetic tape by a tape manufacturer.

14. The computer readable medium of claim 8, wherein said dust concentration level is determined by an excessive use of a cleaner cartridge.
